(19) United States
(12) Patent Application Publication
(10) Pub. No.: US 2010/0068346 A1
(43) Pub. Date: Mar. 18, 2010

(54) INFANT FORMULA

(76) Inventor: Everett L. Hodges, San Clemente, CA (US)

Correspondence Address: STETINA BRUNDA GARRED & BRUCKER, 75 ENTERPRISE, SUITE 250, ALISO VIEJO, CA, 92656, US

(21) Appl. No.: 12/211,699

(22) Filed: Sep. 16, 2008

(51) Int. Cl. A23L 1/304; A23C 9/00; A23L 1/303

(52) U.S. Cl. 426/73; 426/580; 426/74

(57) ABSTRACT

An infant formula is provided which is cow's milk, hydroisolate, rice, goat's milk and/or soy based. The infant formula may be processed such that its manganese concentration is lower than an average manganese concentration associated with the infant formula base. Further, the infant formula may be fortified with iron (lactoferrin), calcium, vitamin D and omega 3 fatty acids to help maintain a neonate's manganese absorption rate at a normal or otherwise acceptable level.

### CROSS-REFERENCE TO RELATED APPLICATIONS

Not Applicable

### STATEMENT RE: FEDERALLY SPONSORED RESEARCH/DEVELOPMENT

Not Applicable

### BACKGROUND OF THE INVENTION

The present invention relates generally to infant formula, and more particularly an improved infant formula with a manganese (Mn) concentration substantially lower than normal with respect to its base and fortified with minerals and vitamins to maintain manganese absorption in neonates within a normal range.

The United States is one of the most violent countries in the world when compared to other industrialized nations. In support thereof, in 1991, the National Center for Health Statistics reported that the homicide rate for males between the ages 15 and 24 in the United States was 37.2 homicides per 100,000 population. In contrast, in Italy, the homicide rate was 4.3 homicides per 100,000 population. Additionally, violence is not limited to certain social groups or geographical areas despite the belief that violent behavior is associated with only specific races, educational levels or geographical areas. Simply put, violence affects everyone despite their age, income, racial or ethnic group.

In a 1994 report, the California Attorney General convened a council to study violence and strategies to reverse the violent culture of our society. The report stated that violence is attributed to many factors but was primarily a “learned” behavior. Further, the report listed the following causal and contributing factors: alcohol and other drugs, educational decline, devaluing of life, discrimination, media influence, mental health problems, economic poverty, hopelessness, corporate promotion, lack of responsibility, isolation and alienation and access to firearms. Also, the Report provided strategies to reduce violence in the United States relating to the media, firearms, alcohol, community, family, relationships, youth, respect for diversity, personal and social responsibility, and research and evaluation. In this regard, the Report focused on “unlearning” violent behavior and minimized or ignored biochemical causes of violence.

In this regard, the causes of violence related to sources other than those mentioned above which relate to the “learning” of violent behavior have largely been minimized or otherwise ignored. Accordingly, there is a need to identify causes of violence other than those associated with the “learning” of violent behavior and to address the identified causes to minimize or eliminate its effect.

### BRIEF SUMMARY OF THE INVENTION

The present invention relates generally to identification of chemical causes of violence. Also, the present invention relates to minimization or elimination of the effect of those identified chemical causes. In this regard, it is believed that a significantly increased manganese uptake in neonates promotes a loss of executive function which can lead to neurological problems, including but not limited to attention deficit with hyperactivity disorder (ADHD). In this regard, an aspect of the present invention is an infant formula having a manganese concentration as close as possible to mother's breast milk (1 mcg Mn/100 calorie serving or 5 ounces). For example, cow's milk based infant formula has approximately 15 mcg of Mn per 100 calories (5 ounces) and soy based infant formula has an average of 30 to 50 mcg of Mn per 100 calories (5 ounces). As such, the infant formula of the present invention will have a maximum of 5 mcg of manganese per 100 calories (5 ounces), the lowest allowable level under present FDA regulations.

As a point of reference, mother's milk contains 1 mcg of Mn per 100 calories (5 ounces), and regular cow's milk contains 4 mcg of Mn per 100 calories (5 ounces). Also, 100 calories (5 ounces) is the amount in a typical baby bottle serving. The current minimum FDA requirement for manganese in formula is 5 mcg per 100 calories (5 ounces) with no set maximum. In summary, all infant formula on the market in the United States today contains at least 5 times the amount of manganese found in mother's milk and up to 50 to 100 times or more, as in the case of soy based formula. In another aspect of the present invention, the infant formula may be fortified with iron (lactoferrin) and/or calcium to reduce the neonate's ability to absorb manganese. Since iron (lactoferrin) and calcium have been found to reduce manganese absorption, the infant formula may also be fortified with nutrients to enhance absorption of these minerals, such as vitamin D.

In another aspect of the present invention, the infant formula will be fortified with nutrients, including DHA and ARA, which are associated with developmental advantages, including infant mental and visual capabilities. In this regard, it is believed that excessive manganese uptake destroys the dopamine and serotonin neurotransmitters. Accordingly, the infant formula may also be fortified with omega 3 fatty acids to decrease free radical distribution of excess manganese on the dopamine and serotonin neurotransmitters. Multiple published animal studies, including primates, have reported that excessive levels of manganese, such as those found in soy based infant formula, destroy statistically significant amounts of the dopamine neurotransmitter in newborn primates. In addition, the animals were reported to suffer from neurological problems that were not exhibited in the control animals fed milk based formula containing the manganese levels of cow's milk. Dopamine deficiency is present in all individuals diagnosed with ADHD. Approximately 4% of the United States' general population is ADHD, as contrasted with over 50% of those in the criminal justice system. In addition, a multi-year published peer review study at the University of California, Irvine (1990, Comprehensive Psychiatry) reported Mn levels in the head hair of aberrant, violent individuals were statistically significantly higher in over 60% of the institutionalized aberrant violent individuals versus 11% of non-violent matched controls.

### BRIEF DESCRIPTION OF THE DRAWINGS

An illustrative and presently preferred embodiment of the invention is shown in the accompanying drawings in which:

FIG. 1 is graph illustrating that a “High Group” exhibits walking at an earlier stage compared to a “Low Group” and a “Control Group” and continues to exhibit an increased level of walking;

FIG. 2 is a graph illustrating that the “Low Group” climbs at an earlier stage which is not developmentally appropriate;

FIG. 3 is a graph illustrating that the “High Group” becomes excessively active and less purposeful in their manual activity;

FIG. 4 is a graph illustrating that the “High Group” engaged in more behavior changes which may be a sign of overactivity;

FIG. 5 is a bar chart illustrating that the “Low Group” and the “High Group” have a 15% decrement dopamine turnover;

FIG. 6 is a bar chart illustrating an inverse relationship between manganese exposure and the level of the serotonin metabolite; and

FIG. 7 is a bar chart illustrating that the “High Group” made many more balks on the reversal test compared to the “Control Group.”

### DETAILED DESCRIPTION OF THE INVENTION

The infant formula of the present invention, as described in this detailed description, is formulated from a soy base. However, it is also contemplated within the scope of the present invention that the various aspects of the present invention described herein may be practiced with other bases to formulate the baby food such as cow's milk, goat's milk, rice, or hydroisolate.

Although the report published by the California Attorney General primarily attributes violent behavior as being “learned”, it is believed that a portion of aberrant, violent behavior (AV) may also be chemically induced. In this regard, it is believed that certain minerals absorbed into a human body at excessive levels may promote violent behavior. Manganese is an essential metal for the survival of every human being. However, exposure to excessive manganese can be devastating as has been reported in over 100 articles over the last 150 years. Ingestion of high levels of manganese, from food, water or air, have been related to neurological disorders, ADHD and AV behavior. Further, studies suggest that absorption of excess manganese in neonates (i.e., 0-4 months old) may promote or cause neurological problems, ADHD and A/V behavior in childhood and later in life. In the neonate, there is no developed homeostatic capability before 4 to 6 months of age. In support thereof, scientific studies show that head hair of ADHD children and prison inmates contain elevated levels of manganese. Societies with a high environmental exposure to manganese exhibit an increased crime rate. Neonates fed with prior art infant formulas containing a normal concentration of manganese have on average an Intelligence Quotient (IQ) of 8.3 points lower when compared to breast fed babies. It is also believed that absorption of excessive manganese destroys the dopamine and serotonin neurotransmitters which are both associated with behavior disorders.

Furthermore, the effects of exposure to high levels of manganese (e.g., environmental exposure or dietary exposure) to the neonate is more detrimental as compared to adults. The reason is that adults have a mechanism to dispense with the excess manganese contained in their diet, whereas neonates do not have the same mechanism and are prone to absorb all available manganese in their diet. In particular, for adults, the excess manganese is generally excreted through the bile. In contrast, bile flow is relatively low for neonates. Moreover, neonates are more prone to absorb the excess manganese because of the general ‘leakiness’ of the gut and the presence of tissue sites with a high affinity for manganese. In support thereof, in animal models, neonatal intestinal absorption of manganese is about 70% to about 80% compared to about 1% to about 2% in adulthood. Consequently, the excess manganese concentration found in prior art infant formulas may not be detrimental to adults but may be detrimental to neonates.

In an aspect of the present invention, the infant formula of the present invention may have a manganese concentration lower than an average manganese concentration related to the infant formula base. In other words, the average manganese concentration of an infant formula may be related to its base. For example, infant formula may be formulated with a soy base, and in this regard, soy based infant formula is 30 to 50 mcg higher than the manganese content in mother's milk. Similarly, infant formula may be formulated with cow's milk, and in this regard, cow's milk based infant formula can contain as low as 5 mcg Mn/5 ouncess. In this regard, the infant formula of the present invention formulated from cow's milk and/or hydroisolate base may have a manganese concentration of 5 mcgMn/5 ounces.

In another aspect of the present invention, the infant formula may be processed such that its manganese concentration will be no more than 5 times the manganese concentration found in mother's breast milk i.e. 5 mcg Mn/100 calories (5 ounces).

In this regard, the infant formula of the present invention may be formulated to resemble mother's breast milk with respect to its nutritional content (i.e., type) and concentration (i.e., amount). The reason is that mother's breast milk is a complex blend of nutrients with respect to type and amount of nutrient and believed to be the optimal complex blend of nutrients necessary for the health and well being of the neonate. For example, mother's breast milk includes the calcium, iron (lactoferrin), proteins, carbohydrates, fat, vitamins and minerals in the appropriate concentrations. Also, mother's breast milk does not contain an excessively high concentration of protein so as to overload the baby's kidneys, and mother's breast milk does contain sufficient amounts of iron (lactoferrin) such that the baby is not irritable, listless or anemic. Simply put, mother's breast milk provides the ideal nutrients and concentrations of those nutrients. It is also believed that a neonate's diet affects the neonate's intelligence, health and well being during the neonate's adult years.

Even though commercially prepared infant formula attempts to closely imitate mother's breast milk, such infant formula cannot achieve the exact blend and concentrations of those nutrients. One reason is that such infant formula must be formulated to have a long shelf life. Moreover, the types of nutrients which are added or deleted from the infant formula are dependent upon nutrients which are identified as necessary for healthy baby growth or detrimental in excessive quantities. In this regard, prior art infant formula does not have a manganese concentration lower than the normal manganese concentration in relation to its base, and more particularly, comparable to the manganese concentration of mother's breast milk.

An experiment was performed to show the association between excessive manganese absorption and A/V behavior. In this experiment, male rhesus monkeys were tested by providing three groups of eight monkeys. The three groups were fed infant formula containing varying levels (i.e., concentrations) of manganese from the time of birth till they were 18 months old. Male rhesus monkeys were selected because of their similarity to humans with respect to maturity of brain development at birth, prolonged period of postnatal brain development and complexity of behavioral repertoire. A first group (i.e., control group) of eight monkeys were fed experimental formula which consisted of cow's milk based infant formula having 0.03 microgram Mn/mL. A second group (i.e., low group) of eight monkeys were fed experimental formula which consisted of soy based infant formula having 0.3 microgram Mn/mL. Lastly, a third group (i.e., high group) of eight monkeys were fed experimental formula which consisted of soy based infant formula with added manganese having 1 microgram of Mn/mL. The experimental formulae were fed to the respective groups of monkeys during the first four months of the monkey's life.

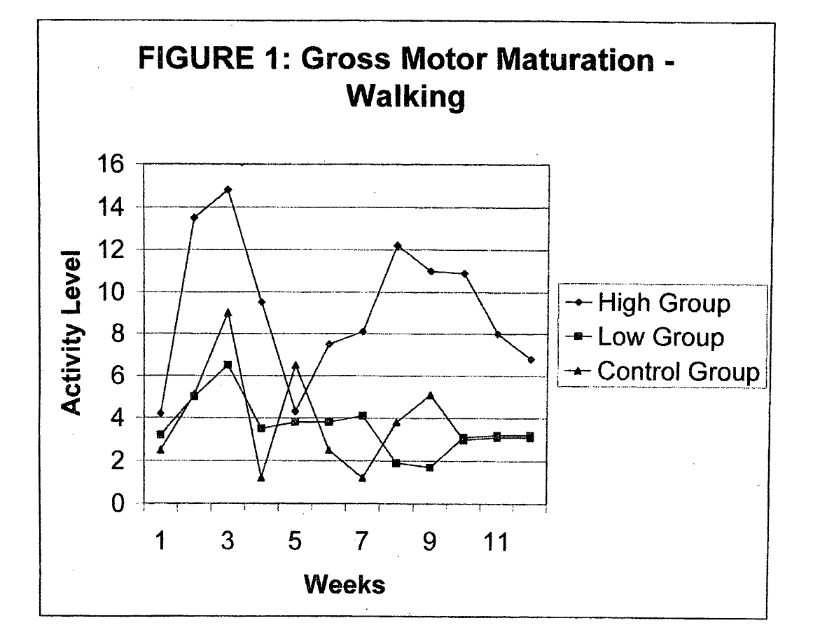

During the four month period, each monkey was observed with respect to gross motor maturation (i.e., walking, climbing, manual activity and behavior changes), level of the major metabolite of dopamine, level of serotonin metabolite, an indication of serotonin turnover and discrimination reversal task, The results of which are shown in FIGS. 1-7. FIG. 1 illustrates the observations of the monkeys with respect to walking. In this regard, the control group and low group followed a developmentally appropriate pattern, namely an early increase in walking which eventually tapered off. In contrast, the high group was more active earlier than the control and low groups and continued to be more active.

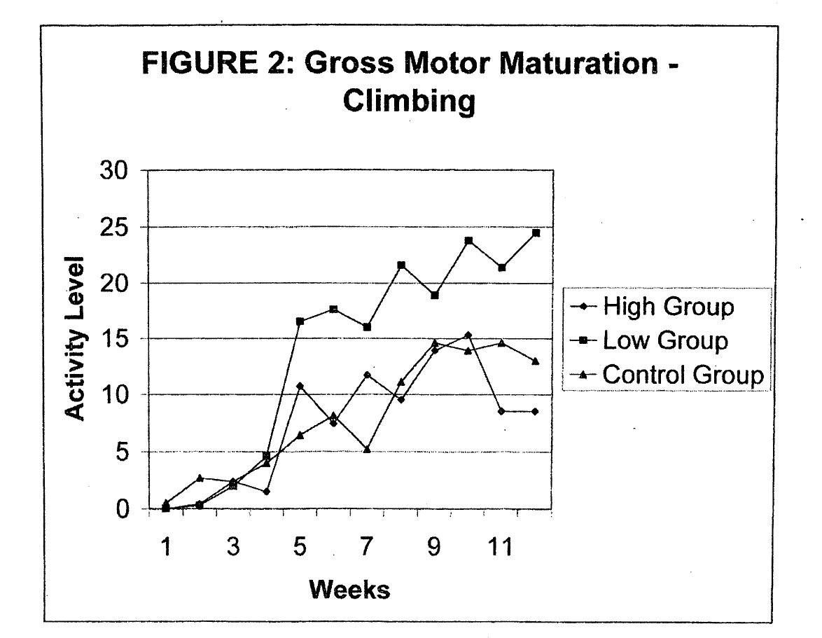

FIG. 2 illustrates the observations of the monkeys with respect to climbing. In this regard, the control and high groups exhibited normal patterns of gross motor maturation. In particular, both groups started climbing at about the fifth week and leveled off at about the eighth or ninth week. The low group also started to climb at about the fifth week but was more active in climbing compared to the control or high groups which may be described as “agitated” or overexuberant climbing. One possible reason that the high group exhibits normal gross motor maturation with respect to climbing may be that this group is still agitated with respect to walking (see FIG. 1) which is a more primitive form of behavior compared to climbing.

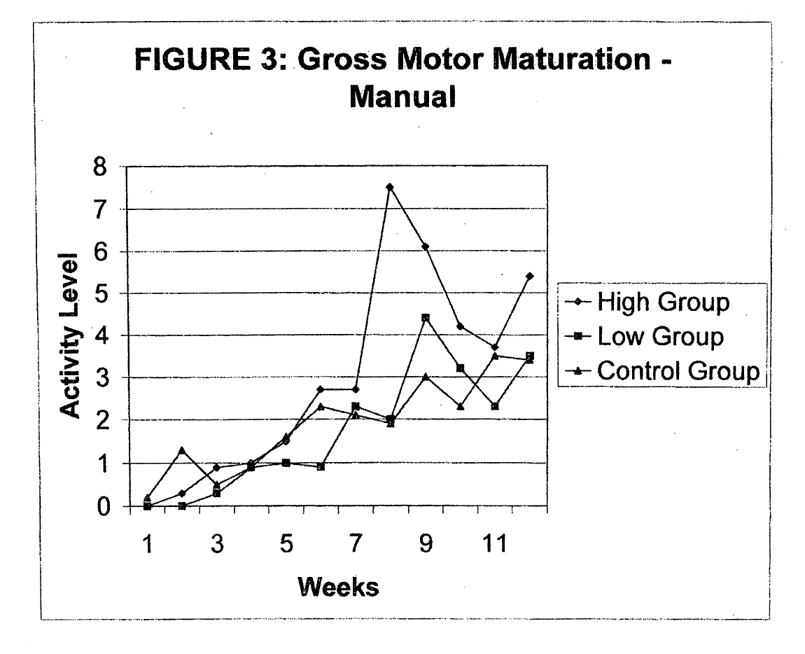

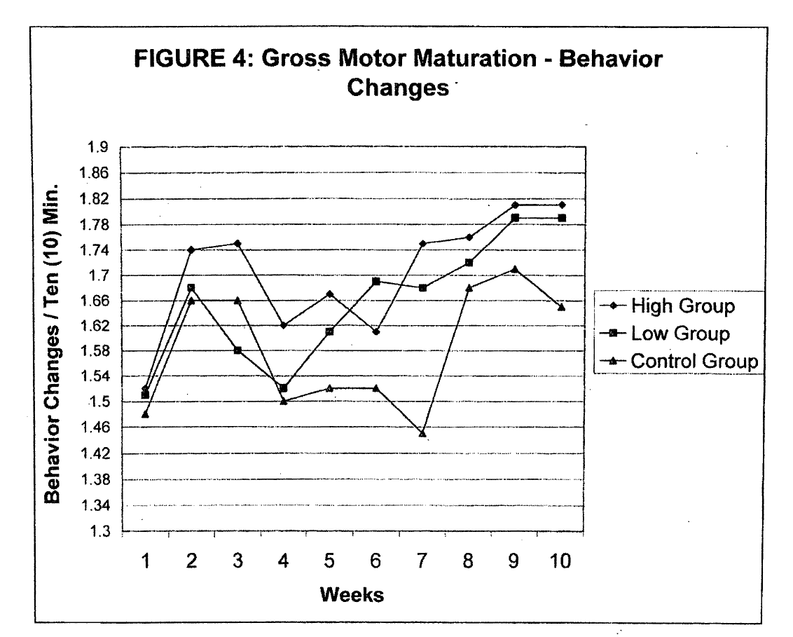

FIG. 3 illustrates the observations of the monkeys with respect to manual activity. In this regard, the control and low groups exhibited a gradual increase in manual activity over twelve months which is a normal gross motor maturation. However, the high group was overly active and less purposeful in their manual activity. FIG. 4 illustrates the observations of the monkeys with respect to behavior changes. In this regard, the low and high groups exhibited more behavior changes, a sign of overactivity compared to the control group.

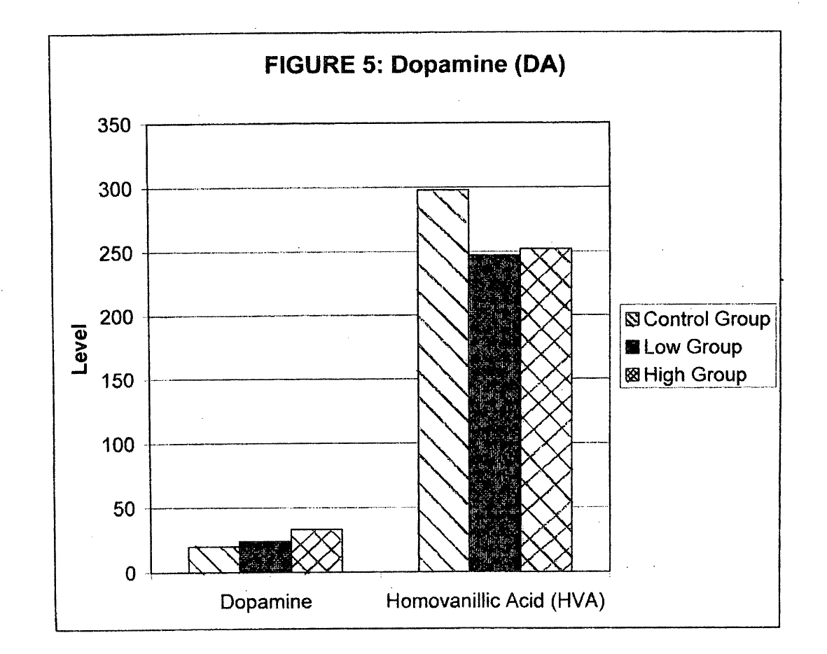

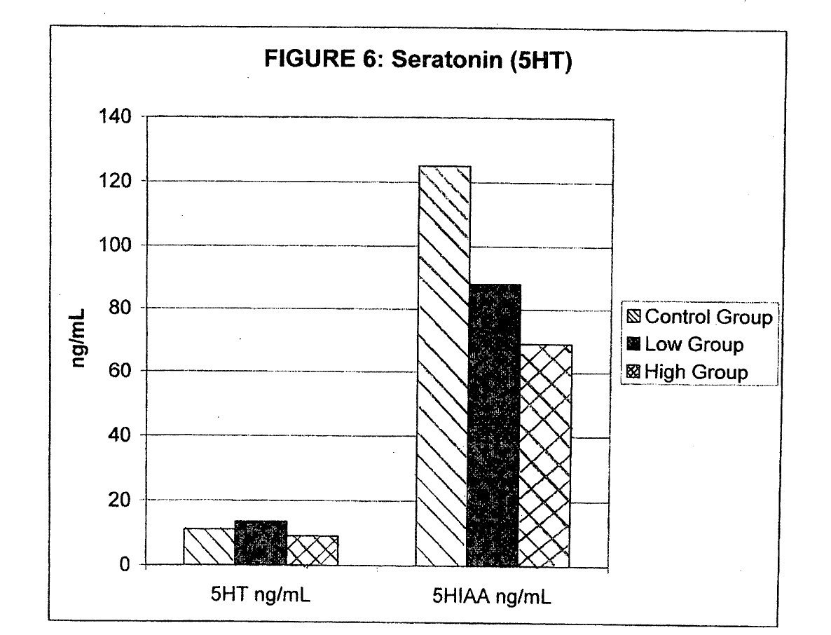

FIG. 5 illustrates the levels of dopamine and its major metabolite (i.e., homovanillic acid or HVA). In particular, there was no difference between the levels of dopamine for the three groups. However, the low and high groups exhibited a 15% decrement dopamine turnover. FIG. 6 illustrates the level of serotonin and its major metabolite (i.e., 5-hydroxyindoleacetic acid or 5HIAA). In particular, there was no difference between the levels of serotonin for the three groups. However, there was an inverse relationship between the concentration of manganese and the level of 5HIAA. The low group had about 75% of the 5HIAA compared to the control group, and the high group had about 60% of the 5HIAA compared to the control group.

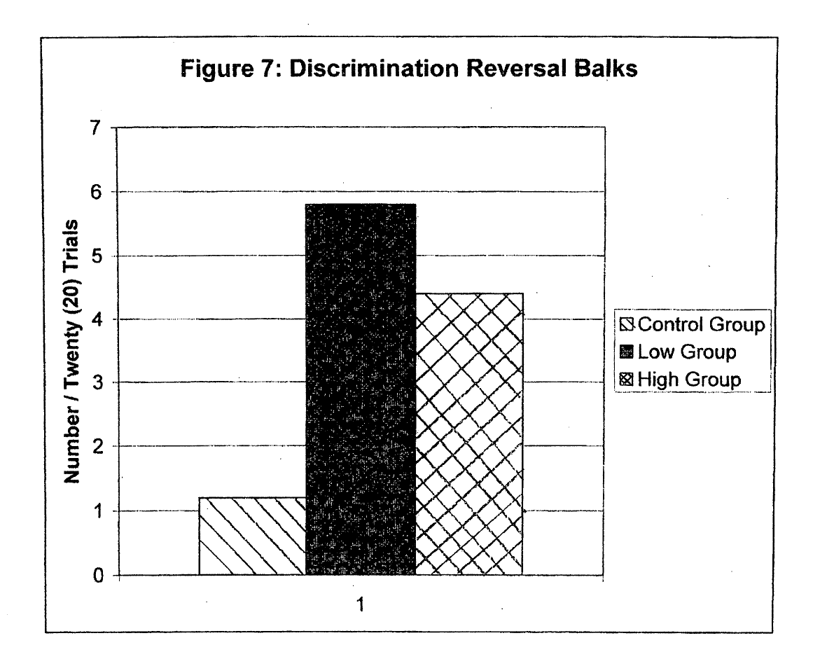

FIG. 7 illustrates the monkey's ability to inhibit an impulsive tendency to persist even though persistence may be futile. In other words, this observation may be similar to the loss of mental flexibility. As shown in FIG. 7, the low group as well as the high group made many more balks on the reversal test compared to the control group. This type of behavior is similar to human children who have attention deficit disorder.

Based on the above-described experiment and its observations, the results after four months show that the low and high groups exhibited aberrant patterns of motor development and that there was a manganese dose-related decrement in major dopamine and serotonin metabolites.

In another aspect of the present invention, the infant formula may be fortified with calcium, iron (lactoferrin), vitamin D and/or omega 3 fatty acids. These minerals, vitamins and acids affect the neonate's ability to absorb manganese as well as the effect of absorbed manganese on neurotransmitters associated with A/V behavior. Calcium may be added to the infant formula in an amount equal to the daily recommended amount for neonates because it is believed that the lack thereof increases a neonate's ability to absorb manganese. Similarly, iron (lactoferrin) may be added to the infant formula in an amount equal to the daily recommended amount for neonates because it is believed that the lack thereof also increases the neonate's ability to absorb manganese. Conversely, providing the daily recommended amounts of calcium and iron (lactoferrin) to neonates ensures that the neonate's ability to absorb is maintained at a normal/acceptable level or at a level comparable to that when the neonate is breast feeding. Vitamin D may be added to the infant formula because vitamin D increases the neonate's ability to absorb calcium which in turn maintains the neonate's ability to absorb manganese at the normal level.

This description of the various embodiments of the present invention is presented to illustrate the preferred embodiments of the present invention, and other inventive concepts may be otherwise variously embodied and employed. The appended claims are intended to be construed to include such variations except insofar as limited by the prior art.

What is claimed is:

1. An infant formula fed to a neonate as a replacement for mother's breast milk, the formula comprising cow's milk concentrate and/or hydroisolate defining a manganese concentration not to exceed 5 mcgMn/5 ounces of formula.

2. The formula of claim 1 further comprising iron (lactoferrin) for reducing a neonate's ability to absorb manganese in the formula.

3. The formula of claim 1 further comprising calcium for reducing a neonate's ability to absorb manganese in the formula.

4. The formula of claim 3 further comprising vitamin D to promote calcium absorption in the neonate.

5. The formula of claim 1 further comprising omega 3 fatty acid to decrease free radical distribution of excess manganese on neurotransmitters of the neonate.

6. An infant formula fed to a neonate as a replacement for mother's breast milk, the formula comprising a rice based isolate defining a manganese concentration, the isolate manganese concentration being about a manganese concentration of mother's breast milk.

7. The formula of claim 6 further comprising iron (lactoferrin) for reducing the neonate's ability to absorb manganese in the formula.

8. The formula of claim 6 further comprising calcium for reducing the neonate's ability to absorb manganese in the formula.

9. The formula of claim 8 further comprising vitamin D to promote calcium absorption in the neonate.

10. The formula of claim 6 further comprising omega 3 fatty acid to decrease free radical distribution of excess manganese on neurotransmitters of the neonate.

11. An infant formula fed to a neonate as a replacement for mother's breast milk, the formula comprising a cow or hydroisolate base or a soy based isolate having a manganese concentration lower than an average manganese concentration related to the above-noted formulas.
